(19) United States
(12) Patent Application Publication
(10) Pub. No.: US 2013/0180099 A1
(43) Pub. Date: Jul. 18, 2013

(54) Table Connector System and Method of Assembly

(71) Applicants: Michael Issac Weaker, North Potomac, MD (US); Matthew A. Sommerfield, Allentown, PA (US)

(72) Inventors: Michael Issac Weaker, North Potomac, MD (US); Matthew A. Sommerfield, Allentown, PA (US)

(21) Appl. No.: 13/352,453

(22) Filed: Jan. 18, 2012

(51) Int. Cl. F16B 12/44; B23P 11/00; F16B 12/10

(52) U.S. Cl. 29/525.11; 411/366.1; 403/403

(57) ABSTRACT

There is provided in a preferred embodiment of the present invention a connector system and method of assembly comprising a frame and a plurality of legs that are combined to form a table. The frame includes a plurality of side members having an open interior and a plurality of corner members that are positioned in the interior of the side members. A plurality of bolts is positioned through the frame and into the legs to secure the frame to the legs and form a table.

### FIELD OF THE INVENTION

This invention relates generally to the field of furniture connector systems. More specifically, this invention involves a connector system for a table or similar furniture units, which minimizes the appearance of seams and connection parts. In a preferred embodiment, the connector system includes four side members that are connected by four corner members and plurality of bolts and pins.

### BACKGROUND OF THE INVENTION

Conventional wood furniture is assembled using nuts and bolts and other visible fastening devices. Metal and plastic furniture are generally assembled in a manner similar to wooden furniture.

There are several problems associated with conventional furniture assembly devices. For example, nuts and bolts are visible to the user and detract from the appearance of the furniture. Further, exterior fasteners of this type tend to attract debris and rust and are more difficult to clean, and may often “catch” on clothing or “scratch” a user.

Another furniture assembly technique, exterior welding, is limited because it leaves visible seams, lacks strength and is difficult to disassemble. Welding the exterior of one element to the exterior of an adjacent element requires melting the metal at the junction and/or adding melted metal to the area to fix the two elements together. The melted metal generally forms a visible seam, which detracts from the appearance of the furniture. Additionally, it is often costly, as it requires skilled labor.

Further, a welding junction can only be disassembled by remelting the metal in the junction. This process requires specialized welding equipment and greatly limits the ability to disassemble the furniture.

### SUMMARY OF THE INVENTION

In view of the deficiencies and drawbacks in the prior furniture assembly and connection art, it is a primary object of the present invention to provide an improved table connector system and method of assembly that minimizes the visibility of junctions.

Another object of the present invention is to provide an improved connector assembly for tables and other furniture units that provides additional strength when working with lighter metals such as aluminum.

A further object of the present invention is to provide a simple and efficient method of assembling a table using a table connector system.

In summary, there is provided in the present invention a connector system and method of assembly comprising a frame connected to a plurality of legs. The frame includes a plurality of side members having hollow interiors and a plurality of corner members having two segments. The first segment of a corner member is positioned inside the interior of a first side member and the second segment of the same corner member is positioned inside the interior of a second side member. This configuration is repeated for the entire plurality of side member and corner members, which preferably includes four each. The combined side member and corner members are fixed together by a plurality of pins and bolts forming the frame. The frame is then fixed to each leg by a series of bolts.

### BRIEF DESCRIPTION OF THE DRAWINGS

FIG. 1 is a perspective view of a table incorporating an embodiment of the table connector system, the same integrating the method of assembly of the present invention;

FIG. 2 is a top plan view thereof, partially broken away to reveal a lower right portion thereof, and a an upper left portion thereof;

FIG. 3 is a cross section view of the leg and side member of the table connector system, taken along line 3-3 of FIG. 2;

FIG. 3A is a perspective view of the threaded bolt used in the table connector system;

FIG. 4 is a cross section view of two joined side members of the table connector system, taken along line 4-4 of FIG. 3;

FIG. 5 is a cross section view of a side member of the table connector system, taken along line 5-5 of FIG. 3;

FIG. 6 is a perspective view of the leg and foot of the table connector system;

FIG. 7 is cross section view of the leg of the table connector system, taken along line 7-7 of FIG. 6;

FIG. 8 is an exploded view of two side members and a corner member of the table connector system; and

FIG. 9 is an exploded view of two assembled side members and two pins of the table connector system.

### DETAILED DESCRIPTION OF THE INVENTION

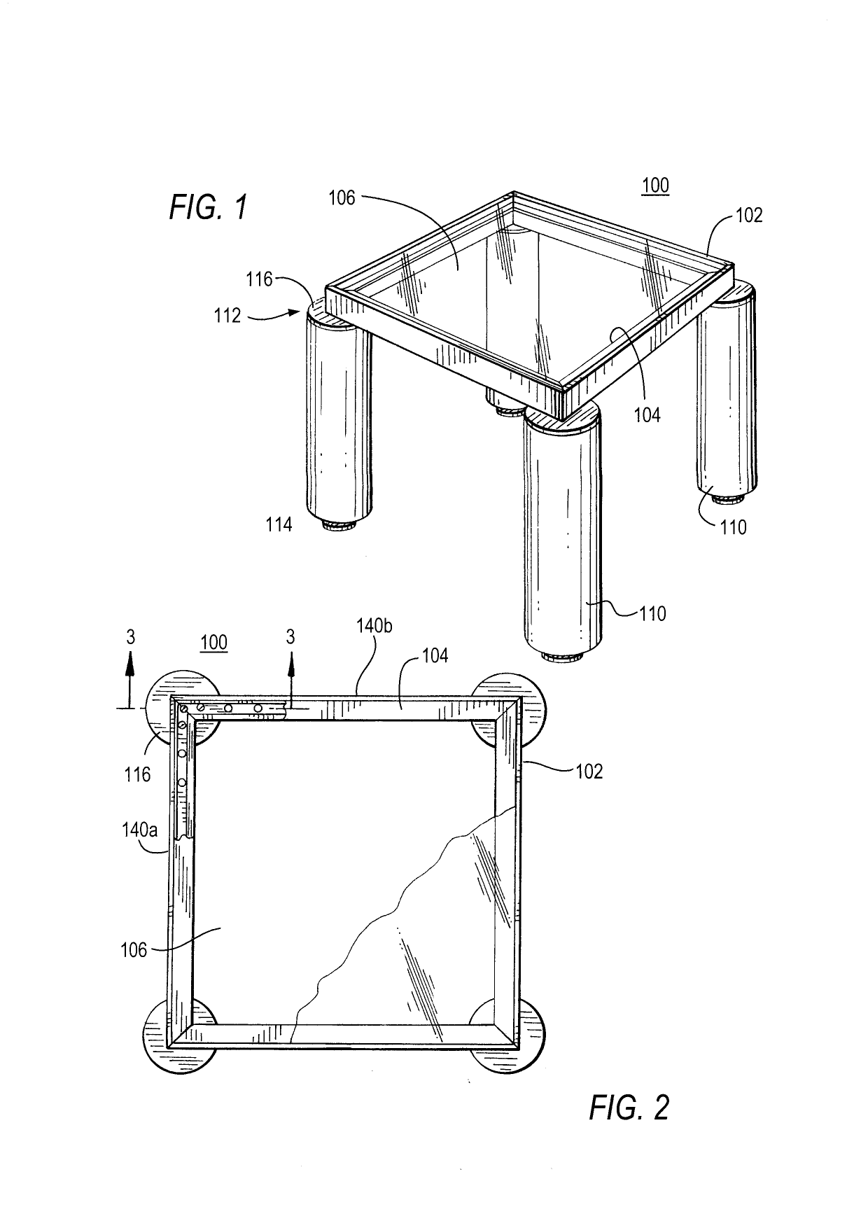

With reference to FIGS. 1 and 2, there is shown a table 100 of the present invention. The table 100 includes a frame 102, table top support surfaces 104 (arranged in a square formation), a table top 106, and legs 110. In the preferred embodiment shown in FIGS. 1 and 2, the table 100 includes four parallel legs 110. Further, the table top support surfaces 104 are preferably constructed of plastic and prevent the table top 106 from being damaged by the various other elements of the table 100. Preferably, there are four abutting table top support surfaces 104 and each corresponds to a side of the table 100. The table top 106 is preferably constructed of a transparent material such as glass.

FIGS. 1, 3, 6 and 7 illustrate the detailed construction of the legs 110. Each leg 110 includes a top end 112 and a bottom end 114. As shown in FIGS. 6 and 7, each leg further includes an interior elongated leg web 126 with four cross members 126a, 126b, 126c and 126d. In the center of the leg 110 is a central boss 128, having at its top end a threaded central boss bore 130. Two of the cross members, 126a and 126b include bosses 132, having at their top ends threaded side boss bores 134. At the bottom end 114, the leg 110 includes a foot 136, having a foot threaded bolt 138. The foot threaded bolt 138 adjustably connects to a foot bolt bore 139 in the central boss 128 at the bottom end 114 of the leg 110.

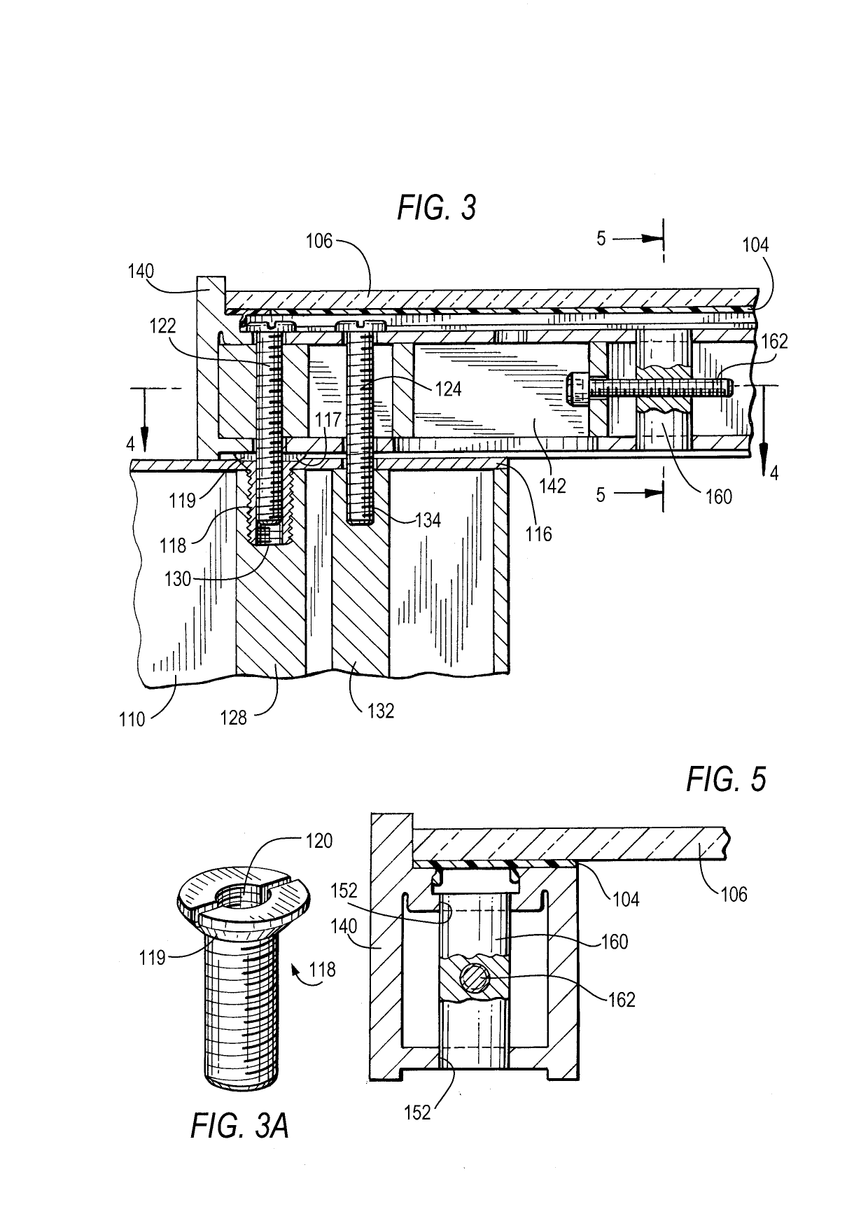

Preferably, leg 110 is formed from an aluminum extrusion tube which includes the leg web 126, the central boss 128 and the side bosses 132. The central boss 128 is tapped to form the threaded central boss bore 130 at the top end 112 and the foot bolt bore 139 at the bottom end 114. The two side bosses 132 are tapped to form the threaded side boss bores 134 at the top end 112, See FIG. 3.

The cross-section view of FIG. 3 illustrates the connection of a leg 110 to the frame 102. For purposes of this connection, the leg 110 further includes a threaded bolt 118, having a central opening 120. The threaded bolt 118 is shown alone in FIG. 3A. The threaded bolt 118 is positioned through a top end leg cap 116 for leg 110 and into the threaded central boss bore 130, thereby securing the threaded bolt 118 and the top end leg cap 116 to the leg 110. Threaded bolt 118 has a cone-shaped head 119. The cone-shaped head 119 is adapted to fit into a matching cylindrical opening 117 in leg cap 116 creating an interference fit between the threaded bolt 118 and the leg cap 116. All four legs 110 are similarly connected to leg caps 116.

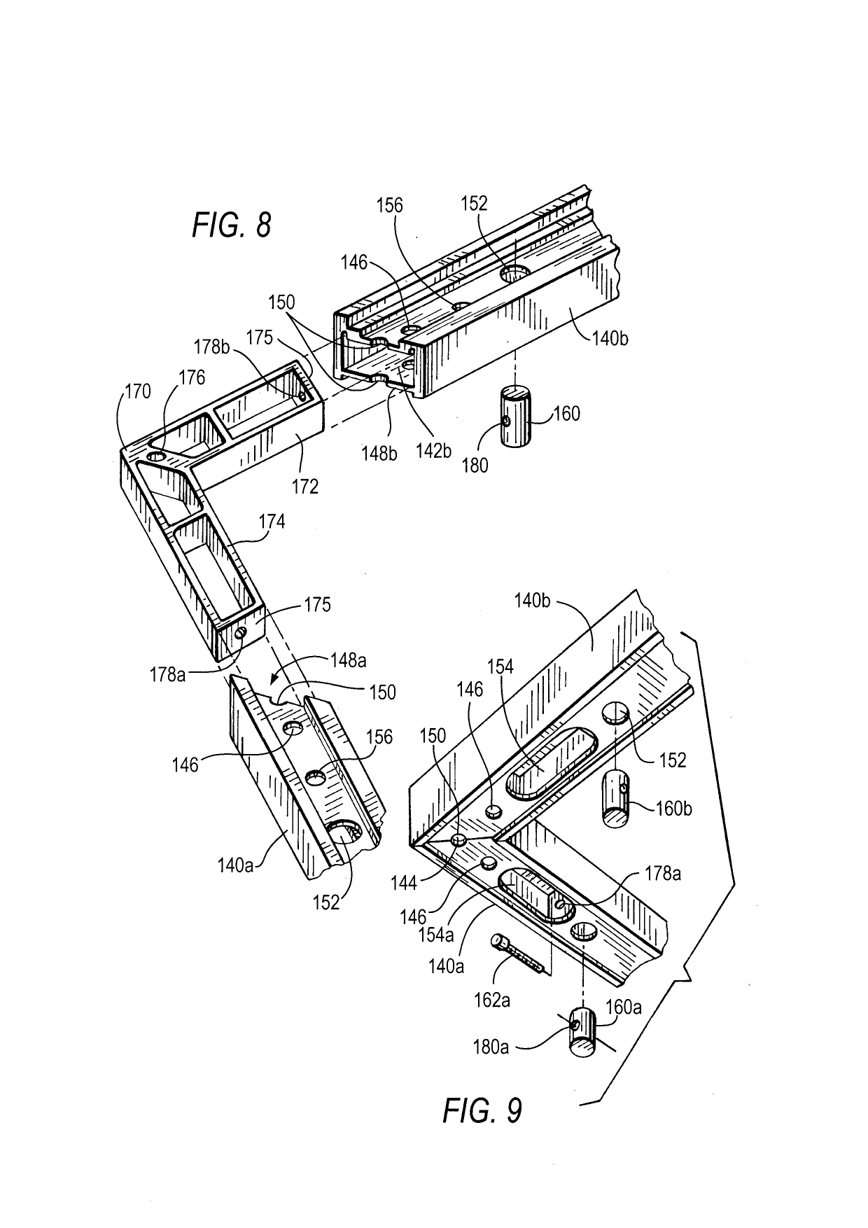

The exploded view of FIG. 8 shows the construction of the frame 102, including the connection of two side members 140 (specifically 140a and 140b) to a corner member 170. In total, the frame 102 is preferably constructed of four side members 140 and four corner members 170. Each corner member 170 includes a first segment 172 and a second segment 174. The first segment 172 and the second segment 174 are preferably positioned at right angles to one another and are integrated into a single piece. The side members 140 include hollow interiors 142, specifically, side member 140b includes a hollow interior 142b.

Additionally, each side member 140 each include two angled sides 148, one at each opposing end. The angled sides 148 comprise a rectangular border around the hollow interior 142 and include two pairs of opposing parallel edges. The surface of the angled sides 148 are preferably 45 degrees relative to their direction of length. The interior 142b of side member 140b is adapted to slidingly receive the first segment 172 of the side member 170. Further, the interior 142a of a second side member 140a is adapted to receive the second segment 174 of the side member 170. Thus, as shown prior to assembly in FIG. 8 and after assembly in FIG. 9, the corner member 170 is enclosed by the two side members 140a and 140b.

As illustrated in FIGS. 3, 5 and 9, the table 100 further includes eight tapped pins 160, two for each side member 140, where each tapped pin 160 includes a threaded boss opening 180. The tapped pins 160 are positioned in pin slots 152 of the side members 140. FIG. 9 shows two tapped pins 160a and 160b positioned in side members 140a and 140b, respectively. A pin bolt 162, shown in FIGS. 3, 5 and 9, passes through a side pin bolt opening 178 of a side wall 175 of the corner member 170 and into the pin threaded boss opening 180. Each side member 140 is secured to two corner members 170, one at each end, by the pin bolt 162. As shown in FIGS. 8 and 9, a pin bolt 162a is positioned through the side pin bolt opening 178a and is secured to tapped pin 160a, thereby securing side member 140a to corner 170. Similar arrangements connect the side member 140b to the corner member 170 as well as the remaining side members 140 to corresponding corner members 170.

Each side member 140 includes indents 150 on the angled side 148. The indents 150 are preferably semi-circular, and are best shown in FIG. 8. When two adjacent side members 140a and 140b slide over a corner member 170, as discussed above, an angled side 148a of the side member 140a meets an angled side 148b of an adjacent side member 140b. When the two angled sides 148a and 148b meet, the indents 150 of the side member 140a and 140b connect to form a central bolt opening 144. Where the indents 150 are semi-circular, the central bolt opening 144 is circular. The central bolt opening 144 is thereby aligned with a corner bolt opening 176 which is located in corner member 170. Accordingly, four continuous vertically aligned openings are provided at the four corners of the frame 102, where adjacent side members 140 meet.

Referring back to FIG. 3, the legs 110 are attached to the frame 102 by a plurality of central bolts 122 and outer bolts 124. Preferably, each leg 110 is attached by one central bolt 122 and two outer bolts 124. Each central bolt 122 is positioned through the central bolt opening 144, through the corner bolt slot 176 and into the central opening 120 of the threaded bolt 118. The outer bolts 124 are positioned through a plurality of outer bolt openings 146 of the side members 140 and into the threaded side boss bores 134 of the legs 110.

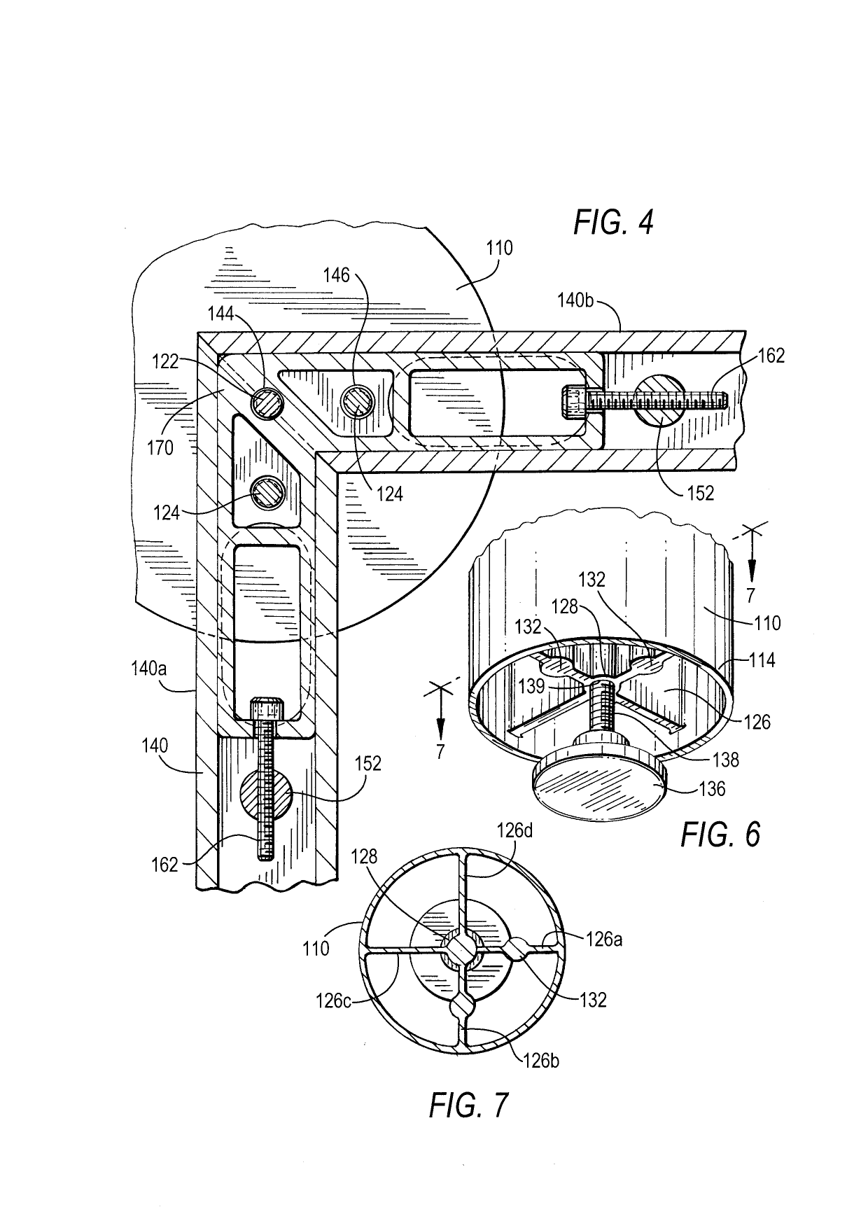

As shown in FIGS. 2, 4 and 8, the side members 140 further include a drain slot 156. The drain slot 156 is provided to allow rain water to flow from the table top 106 through the table 100 with minimal pooling or retention of water. Additionally, the oval opening 154 provides access to side pin bolt slot 178 during assembly.

The preferred method of assembling of the table 100 of the present invention involves separately assembling the frame 102 and the legs 110, and then connecting the legs 110 to the frame 102. While many of the steps are described in a particular order, the particular order is only a preferred example; the steps may be performed in a number of different orders, only one of which is described herein.

The legs 110 are all manufactured from extrusion members. For the legs 110, the extrusion member is cut to the conforming length and then the central boss 128 is tapped on the top end 112 of the legs 110 to form the threaded central boss bore 130. Further, the side bosses 132 are tapped on the top end to form the threaded side boss bores 134 and the central boss 128 is tapped on the bottom end 114 to form the foot bolt bore 139.

The side members 140 are similarly formed from extrusion members. The side members 140 are cut to the conforming length using an angled cut that forms the angled sides 148. The side members 140 are then drilled or reamed to form indents 150, outer bolt openings 146, drain slots 156, pin slots 152 and oval openings 154.

The frame 102 is assembled by inserting the first segment 172 of a corner member 170 into the interior 142 of a side member 140. Then the second segment 174 of the corner member 174 is inserted into the interior 142 of a second side member 140. Illustratively, FIG. 8 shows the first segment 172 about to be inserted into interior 142b and the second segment 174 about to be inserted into interior 142a. The process is repeated with a second corner member 170 and third and fourth side members 140. This creates two sections of the frame 102, where each section includes two side members 140 having two opposite vacant interiors 142. The two sections are then combined by inserting the opposing segments 172, 174 of third and fourth corner members 170 into the vacant interiors 142 of the side members 140, as was described above for interiors 142a and 142b.

Eight tapped pins 160 are used to hold the frame 102 together. The pins 160 are each inserted into pin slots 152 in the side members 140—two pins 160 in each side member 140. Upon insertion, the tapped pins 160 are rotated to align their threaded boss openings 180 with the respective side pin bolt slots 178 of the corner members 170. The insertion of the pins 160 is best illustrated in FIG. 9. Then, using the oval opening 154a as an access point, the pin bolt 162a is inserted through the side pin bolt opening 178a and into the threaded boss opening 180a thereby fixing the side member 140a to the corner member 170.

The legs 110 are assembled by inserting the foot threaded bolt 138 of the foot 136 into the foot bolt bore 139 of the central boss 128. Additionally, the leg cap 116 is positioned over the leg top end 112 and the threaded bolt 118 is positioned through the cylindrical opening 117 and into the threaded central boss bore 130, thereby securing the leg cap 116 to the leg 110.

Each leg 110 is then secured to the frame 102 by a central bolt 122 and two outer bolts 124. The central bolt 122 is inserted through the central bolt opening 144 and the corner member bolt slot 176 into the central opening 120 in the threaded bolt 118. The outer bolts 124 are inserted through the outer bolt openings 146 and into the threaded side boss bores 134.

Once the legs 110 are secured to the frame 102, the table top support surfaces 104 are positioned on the frame and the table top 106 is positioned on the table top support surface 104.

The accompanying drawings only illustrate a preferred embodiment of a connector system and method of assembly and its respective constituent parts and steps, however, other types and styles are possible, and the drawings are not intended to be limited in that regard. Thus, although the description above and accompanying drawings contains much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. In an article of furniture having a plurality of legs and a frame for supporting a table top, a connector system for connecting the legs to the frame, comprising:
a plurality of side members, each side member including an interior and having opposing angled sides;
a plurality of corner members, each corner member including a first segment and a second segment, the first segment positioned at an angle to the second segment, wherein each corner member includes a first end and a opposite second end;
wherein the first segment of a first corner member is positioned inside the interior of a first side member, and the second segment of the first corner member is positioned inside the interior of a second side member;
wherein the legs each include a top end and a bottom end, the top end having a bore, wherein a threaded bolt having an opening is positioned inside the bore and the threaded bolt receives a bolt, positioned through an opening in the frame, and secured to the opening in the threaded bolt.

2. The connector system for connecting a plurality of legs to a frame of claim 1, wherein the corner member includes an end having a bolt opening; and
the connector system further comprises a tapped pin positioned in the interior of the first side member, wherein the tapped pin includes an opening for receiving a pin bolt, the pin bolt fixing the side member to the corner member.

3. The connector system for connecting a plurality of legs to a frame of claim 1, wherein each leg includes a web having a central boss and a side boss.

4. The connector system for connecting a plurality of legs to a frame of claim 3, wherein the bore is positioned in the boss.

5. The connector system for connecting a plurality of legs to a frame of claim 1, wherein the side member includes an outer bolt opening and the side boss includes a side boss bore;
wherein a side bolt is positioned through the outer bolt opening and in the side boss bore.

6. The connector system for connecting a plurality of legs to a frame of claim 1, including four side members and four corner members.

7. The connector system for connecting a plurality of legs to a frame of claim 1, wherein the legs and the side members are extrusion members.

8. The connector system for connecting a plurality of legs to a frame of claim 1, wherein the connector system is constructed of Aluminum.

9. The connector system for connecting a plurality of legs to a frame of claim 1, wherein the opposing angled sides each have an indent;
wherein the indent of the first side member is aligned with the indent of the second side member to form an opening in the frame.

10. The connector system for connecting a plurality of legs to a frame of claim 9, wherein the indents are semi-circular.

11. A method of assembling an article of furniture having a frame and plurality of legs, the method comprising the steps of:
dividing an extrusion member to form a leg, the leg having a boss and a side boss; tapping the boss to form a boss bore, and tapping the side boss to from a side boss bore;
securing a leg cap to the top end of the leg by a threaded bolt, wherein the threaded bolt includes an opening;
dividing an extrusion member to form a side member, the side member having an interior;
cutting the side member to form opposite angled sides;
inserting a segment of a corner member into the interior of the side member and inserting a second segment of the corner member into the interior of a second side member;
securing the corner member to the leg by securing a bolt through the corner member and into the opening in the threaded bolt.

12. The method of assembling an article of furniture having a frame and plurality of legs of claim 11, further comprising:
inserting a tapped pin having an opening into the side member;
inserting a bolt into the opening in the tapped pin.

13. The method of assembling an article of furniture having a frame and plurality of legs of claim 11, further comprising:
forming a corner bolt slot in the corner member.

14. The method of assembling an article of furniture having a frame and plurality of legs of claim 11, further comprising:
forming a drain slot in the side member.

15. In an article of furniture, a connector assembly comprising:
a corner member, the corner member including a first segment and a second segment, the first segment positioned at an angle to the second segment, wherein the corner member includes a first end and a second end;
a first side member, the first side member including an interior, and having a first angled side and a second opposing side;
a second side member, the second member including an interior, and having a first angled side and a second opposing side;
wherein the first segment of the corner member is positioned inside the interior of the first side member with the angled side of the first side member facing towards the center of the corner member, and the second segment of the corner member is positioned inside the interior of the second side member with the angled side of the second side member facing towards the center of the corner member.

16. The connector assembly of claim 15, further comprising a pin positioned in the first side member, the pin having a threaded opening and receiving a bolt.

17. The connector assembly of claim 15, wherein the first angled side and the second angled side each has an indent;
wherein the indent of the first angled side is aligned with the indent of the second angled side to form an opening.
